(19) United States
(12) Patent Application Publication
(10) Pub. No.: US 2006/0047577 A1
(43) Pub. Date: Mar. 2, 2006

(54) System and method for electronic list and path through store

(75) Inventors: Timothy Alan Dietz, Austin, TX (US); Lane Thomas Holloway, Pflugerville, TX (US); Marques Benjamin Quiller, Pflugerville, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 10/932,754

(22) Filed: Sep. 2, 2004

(51) Int. Cl. G06Q 30/00

(52) U.S. Cl. 705/26

(57) ABSTRACT

A system and method is provided that matches a shopping list with an order that items are found in a store. The customer prepares an electronic list by browsing through a list of items and selecting which items the customer wishes to purchase. The customer is provided with an identifier to use to retrieve the list at a later time or to print out a path through a store at either a store kiosk or a printer attached to the customer's computer. The customer chooses a store and requests a path through the store for the selected items. The customer's list is used to find the locations of the items in the store and print a path through the store in an optimal fashion for the store. Static and dynamic coupons associated with selected items are printed so that the coupons can be scanned from the resulting printout.

### BACKGROUND OF THE INVENTION

1. Technical Field

The present invention relates in general to a system and method for providing electronic restaurant menus. In particular, the present invention relates to a system and method for providing a wireless electronic menu that interacts with a restaurant server.

2. Description of the Related Art

Shopping at any large store, such as a supermarket, often starts with a customer preparing a list of needed items before going to the store. A hand-made list is often not categorized or grouped and, even if the customer categorizes the list, the order of the categories used by the customer typically varies from the way the items are distributed throughout the store. Exacerbating this problem is the fact that a customer may use different stores to purchase the same type of items.

For example, when grocery shopping during the week, the customer may shop at a supermarket closer to the customer's work location. However, on the weekend, the customer may shop at a supermarket closer to the customer's home. Stores, even those that are commonly owned, are usually laid out in dramatically different fashions. The different layouts of stores may confuse the customer, causing the customer to use a poorly optimized path through the store. The poorly optimized path often causes the customer to pass by items on the customer's list and then backtrack through the store to find the items. The use of a poorly optimized plan results in the customer being inefficient and spending more time than desired to shop for items on the customer's list.

Further complicating this problem is the use of coupons when buying products on the customer's shopping list. Coupons are often separate pieces of paper that are difficult to manage and difficult to match against items on the customer's shopping list. Without knowing the path through a store, it is difficult or impossible to sort the coupons in the same order that the items will be encountered in the store.

What is needed, therefore, is a system and method that uses a customer's list to compute an optimal path through a store. In addition, what is needed is the ability to receive a path that is customized to a store's particular layout. Finally, what is needed is an efficient way of handling coupons and organizing coupons so that the order of the coupons matches the order that the items are encountered in the store.

### SUMMARY

It has been discovered that the aforementioned challenges are resolved with a system and method that matches a customer's shopping list with the order that items are found in a store to optimize the customer's shopping experience. The customer prepares an electronic list by browsing through a list of items and selecting which items the customer is interested in purchasing. In one embodiment, the customer accesses the Internet and uses a web browser to load one or more web pages that detail the items available at a store. The items that the customer chooses are saved in a nonvolatile storage area. The customer is provided with an identifier to use to retrieve the list at a later time or to print out a path through a store. In one embodiment, the identifier that is used is a number, such as the customer's telephone number, that is familiar and readily remembered by the customer.

When the list has been completed, the customer chooses a store (if more than one store is available) and requests a path through the store for the selected items. If the customer is printing the list at a non-store location, such as the customer's home or office, the customer chooses the store from a list of available stores. If the customer arrives at the store, the customer can use a kiosk to enter in the customer's identifier and the processor within the kiosk will retrieve the customer's list and compute a path through the store at which the kiosk is located.

The customer's list is used to find the locations of the items in the store and print a path through the store in an optimal fashion for the particular store. Coupons associated with items on the list are printed so that the coupons can be scanned from the printout rather than requiring the customer to provide coupons clipped from newspapers and other sources. In addition, “dynamic coupons” are provided and printed out. Items on the customer's list are compared to competitive or alternative products. Manufacturers of the competitive or alternative products can request that dynamic coupons advertising the manufacturers' competitive product and printing a coupon in an attempt to entice the customer to switch and decide to purchase the competing or alternative product.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a screen diagram showing a window interface used by a customer to choose items the customer wishes to purchase;

FIG. 2A is a screen diagram showing a window interface used by a customer to select a store, compute a path through the store, and print the path;

FIG. 2B is a screen diagram showing a kiosk interface located at a store location that is used by a customer to compute a path through the store and print the path;

FIG. 3 is an example printout detailing a path through a store for items selected by the customer;

FIG. 4 is a high level flowchart showing steps taken to prepare the list and path through a store;

FIG. 5 is a flowchart showing steps taken to prepare a list for path computation;

FIG. 6 is a flowchart showing steps taken to choose a store location and compute a path through the store;

FIG. 7 is a flowchart showing steps taken to traverse the store and retrieve coupon information;

FIG. 8 is a flowchart showing steps taken to print the customer's list, the path, and coupons;

FIG. 9 is a flowchart showing steps taken to redeem coupons printed on the printout during checkout; and

FIG. 10 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

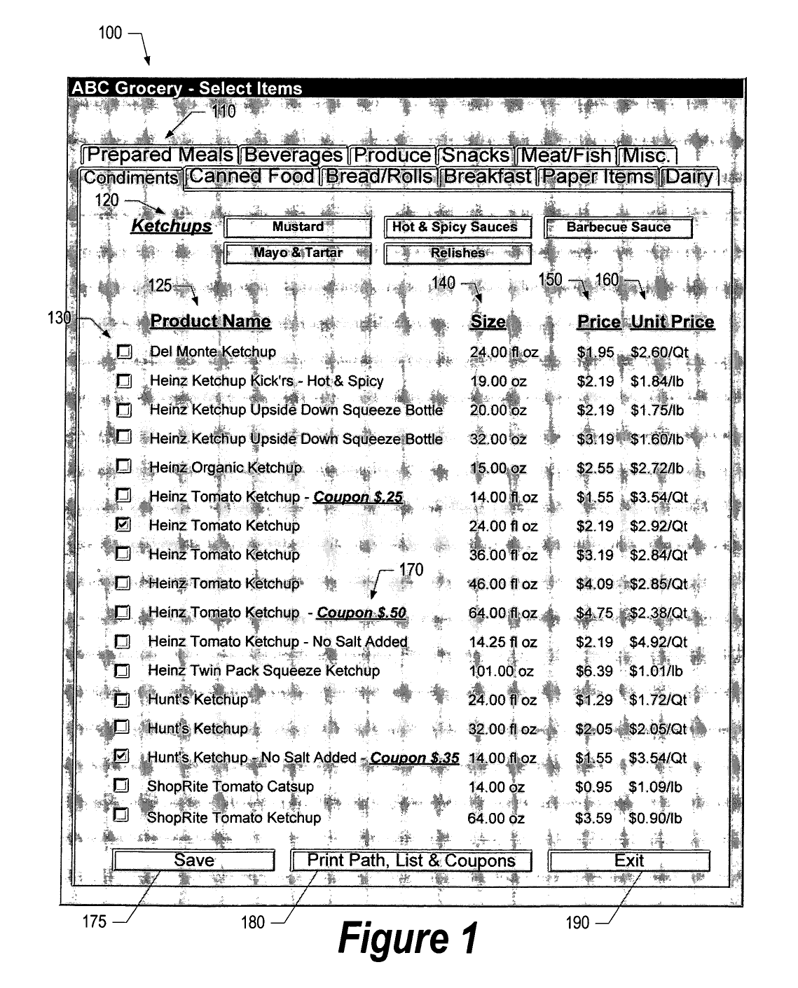

FIG. 1 is a screen diagram showing a window interface used by a customer to choose items the customer wishes to purchase. The customer uses window 100 to browse through the list of available items and select items in which the customer is interested in purchasing. In one embodiment, window 100 is a web page that is available to the customer through the Internet using a web browser application. In the example shown, the items shown in window 100 are available at “ABC Grocery,” as indicted by the title bar of window 100.

The items that are available are organized by category. Menu tabs 110 are used by the user to switch from one category of items to another. In the example shown, various grocery-type categories are provided in menu tabs 110. In the example shown, the user has selected the “condiments” category. Items in a category may further be divided into various subcategories. Command buttons 120 are used to move between the various subcategories. In the example shown, six subcategories are shown within the “condiments” category and the user has selected the “ketchups” subcategory.

Products names 125 available within the category or subcategory are displayed. Checkboxes 130 are provided with one checkbox corresponding to each item displayed. Along with each product name, additional information, such as size 140, price 150, and unit price 160 are provided to provide the customer with additional purchase-making information.

Coupons that are available through the system are printed alongside items to which they apply. In the example shown, there are three “static” coupons that apply to three of the items. If the user selects any of these items, then the corresponding coupons will be printed for the selected items on the customer's printout.

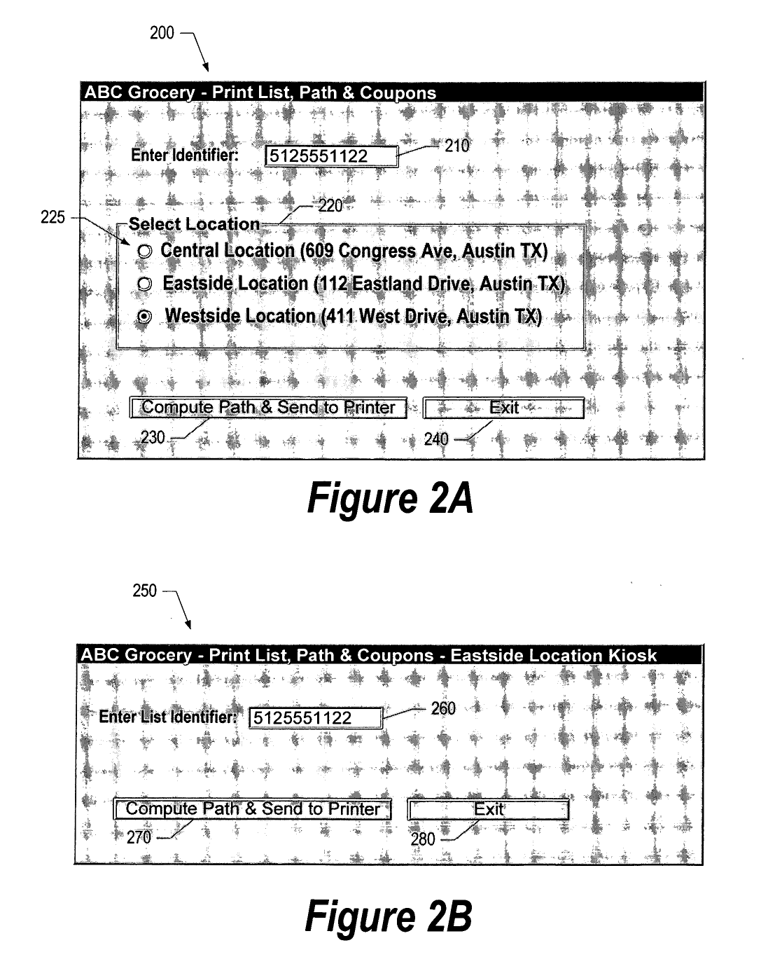

When the customer is finished making selections, he or she selects save command button 175 to save the list. If the customer wants to print the path, list, and coupons on a printer connected to the customer's computer system, the customer presses command button 180 (see FIG. 2A for the dialog that appears after command button 180 is selected). If the customer wants to exit without saving the list, the customer presses exit command button 190.

FIG. 2A is a screen diagram showing a window interface used by a customer to select a store, compute a path through the store, and print the path. Window 200 is displayed to the user when the customer requests to compute the path through a store and print the list when the customer is at a non-store location, such as the customer's home or work location. The customer enters his or her identification number into identification textbox 210. Location frame 220 lists the various stores that the customer may choose. In the example shown, three locations for “ABC Grocery” are listed in frame 220. Within frame 220 there are three options 225 from which the customer can choose along with the address of each location. In the example shown, the user has selected the “Westside” location of ABC Grocery. After the customer has entered the identifier and selected a location, the customer selects command button 230 to compute the path through the selected store and print the list to the customer's printer. If the user decides not to compute the path and print the list, the user selects exit command button 240 to end the dialog.

FIG. 2B is a screen diagram showing a kiosk interface located at a store location that is used by a customer to compute a path through the store and print the path. A kiosk is positioned in the various store locations so the customer can compute a path and send it to a printer connected to the kiosk. In the example shown, the kiosk is located at ABC Grocery's “Eastside” location as noted in the window title bar. Window 250 appears on the kiosk's display. Window 250 includes textbox 260 into which the customer enters an identifier that corresponds to the shopping list that the customer previously created (see FIG. 1 and corresponding text for details regarding the customer's creation of an electronic shopping list). Once the identifier has been entered in textbox 260, the customer selects command button 270 to compute a path through the store and print the list and path on a printer that is connected to the kiosk. If the customer changes his or her mind, he or she can press command button 280 to exit the kiosk interface.

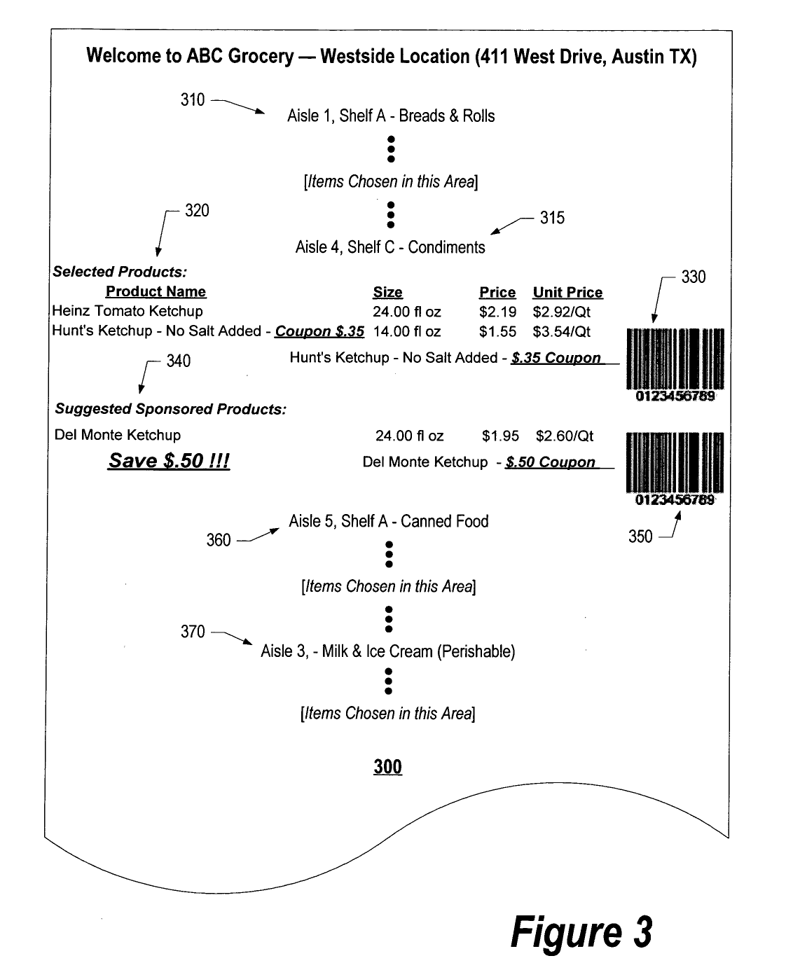

FIG. 3 is an example printout detailing a path through a store for items selected by the customer. This printout can be printed at the customer's printer by using the client interface shown in FIG. 2A or by using the kiosk interface shown in FIG. 2B.

Returning to FIG. 3, printout 300 includes items on the customer's shopping list. The list is arranged in the order that the items appear in a computed path. Note that the computed path does not have to be a straight line through the store. Some items, such as perishable items, may be listed toward the end of the list so that the items do not melt or spoil while the customer is shopping. In the example shown, items from Aisle 3 (370) are printed after items from Aisle 5 (360). This is because items in Aisle 3, such as ice cream, have been identified as perishable. In this manner, the computed path recommends that the customer retrieve the canned food items listed as being found in Aisle 5 before going back to Aisle 3 to retrieve items, such as ice cream. In one embodiment, the path computation takes the number of items on the customer's list into account in deciding whether to print perishable items and their locations toward the end of the printout. So, if the customer is only shopping for ten items, the perishable items in Aisle 3 would be printed before the canned food items in Aisle 5. On the other hand, if the customer is shopping for many items, the perishable items would be printed toward the end of the list, as is shown in the example in FIG. 3.

Except for perishable items, the path through the store is generally listed in the most convenient and efficient order to retrieve the items. In printout 300, the path begins at the front of the store (Aisle 1, Shelf A, 310) and traverses the store in an efficient manner. Items condiment items that appear on the shopping list are detailed as being at Aisle 4, Shelf C (315). The condiments section is detailed by specific item to point out various aspects of printout 300.

Within the condiments section, selected products section 320 lists those condiment items that the customer selected in his or her shopping list. The selections that appear in section 320 match those selections that the customer made in FIG. 1. In this case, two items—a bottle of Heinz brand ketchup for $2.19 and a bottle of Hunt's brand no salt ketchup for $1.55. The Hunt's ketchup includes a static coupon for $0.35 off the price with barcode 330 corresponding to the static coupon. The static coupon is the same as the coupon advertised when the customer was shopping while using the window shown in FIG. 1. In the examples shown herein, a barcode is used as a coupon identifier to identify a particular coupon. However, those skilled in the art will appreciate that other forms of identifiers, such as codes or numbers, can also be used as a coupon identifier.

In FIG. 3, section 340 details suggested sponsored items that are printed in order to entice the customer to purchase a competing or alternative product. In the example shown, a Del Monte brand ketchup is listed as being cheaper than the Heinz brand ketchup and the Del Monte brand ketchup includes a dynamic coupon for $0.50 off, with barcode 350 corresponding to the dynamic coupon. By being “dynamic,” the dynamic coupon was not made available to the customer until after the customer had already selected a competing product. In this case, the sponsor or distributor of Del Monte brand ketchup have offered an incentive to entice customers that have chosen a different brand of ketchup to try the Del Monte brand of ketchup.

When checking out, in one embodiment the static and dynamic coupons that appear on printout 300 are read by a barcode reader. Coupon amounts corresponding to the items that the customer purchased are subtracted from the customer's bill. In another embodiment, the customer's identifier, such as that entered into the windows in FIGS. 2A and 2B, are used to retrieve an electronic version of the customer's shopping list as well as the static and dynamic coupon barcode information. The second embodiment may be preferred in environments where printout 300 may become soiled or damaged. In addition, a customer loyalty card, found in many supermarkets, may be used to retrieve the customer's identifier and, correspondingly, the customer's electronic version of the customer's shopping list.

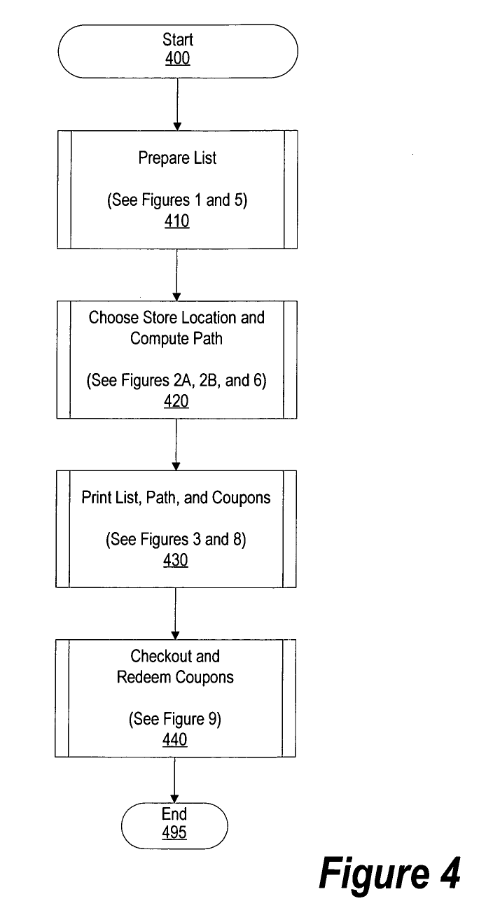

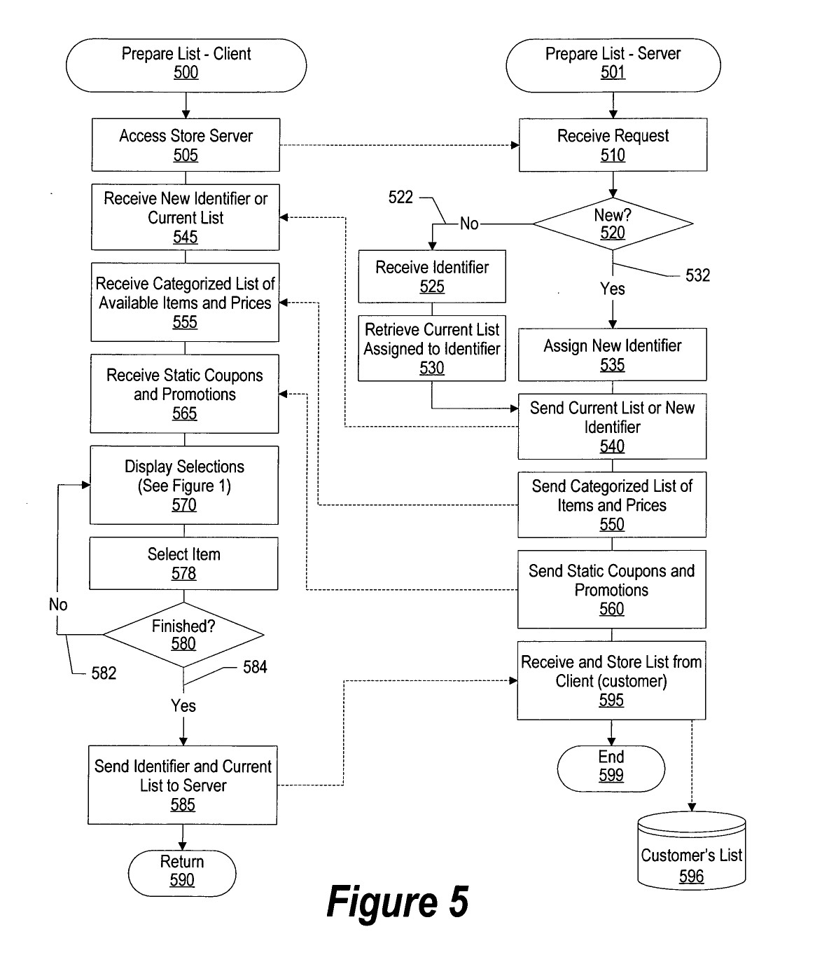

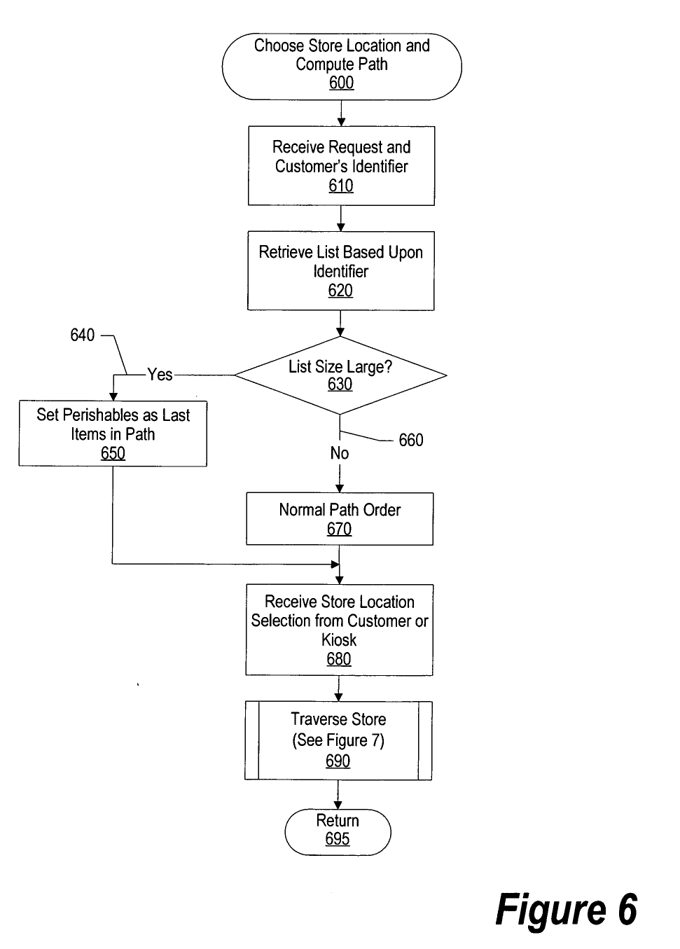

FIG. 4 is a high level flowchart showing steps taken to prepare the list and path through a store. Processing commences at 400 whereupon, at predefined process 410, the customer prepares an electronic shopping list (see FIG. 1 for a window example and FIG. 5 and corresponding text for a flowchart showing the processing details). Once the list is prepared, the customer chooses a store location and the system computes a path through the chosen store (predefined process 420, see FIGS. 2A, 2B, and 6 and their corresponding text for details). The customer can either choose a store by selecting a location on the customers computer (see FIG. 2A), or the customer can choose a store by traveling to the store and using a kiosk found within the store to compute the path (see FIG. 2B). A flowchart showing processing details is depicted in FIG. 6.

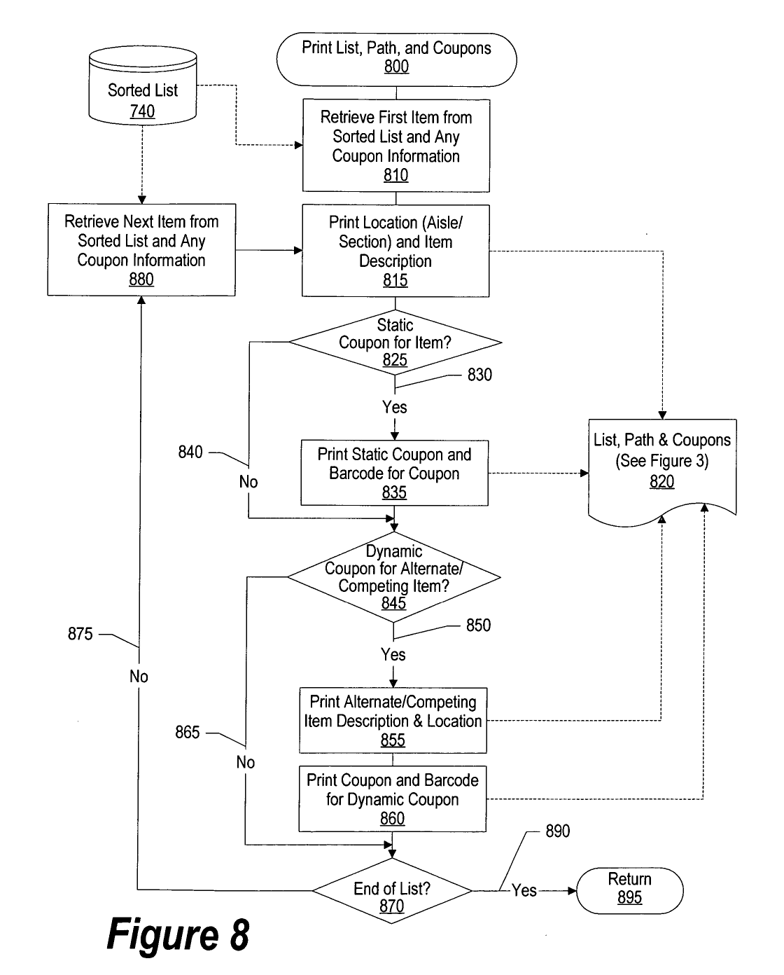

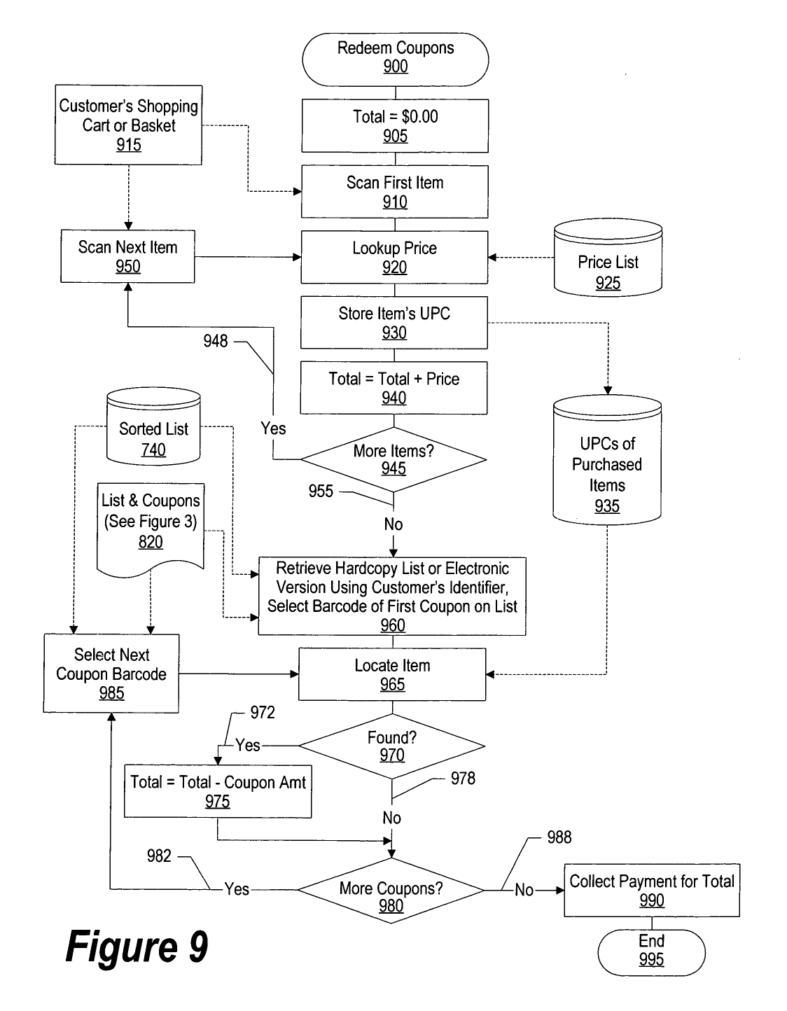

At predefined process 430, the customer prints the customer's list and the computed path through the store along with any coupons that may apply to the items on the customer's list (see FIG. 3 for an example of a printout and FIG. 8 for a flowchart showing processing details. After the customer has retrieved items using the printout that details a path through the store, the customer checks out and redeems any coupons that correspond to any of the items that the customer retrieved and placed in the customer's shopping cart (see FIG. 9 and corresponding text for processing details). Processing thereafter ends at 495.

FIG. 5 is a flowchart showing steps taken to prepare a list for path computation. Client processing (i.e., the computer being used by the customer) commences at 500 whereupon, at step 505, the customer's computer accesses the store's server with a request. Server processing commences at 501 whereupon, at step 510, the server receives the customer's request. A determination is made as to whether the customer is making a new request or already has an existing shopping list (decision 520). If the customer already has an existing list, decision 520 branches to “no” branch 522 whereupon, at step 525 the customer's identifier is retrieved and, at step 530, the customer's current list is retrieved by using the customer's identifier. On the other hand, if the customer does not have an existing shopping list or is using the system for the first time, decision 520 branches to “yes” branch 532 whereupon, at step 535, a new identifier is assigned to the customer.

At step 540 either the customer's current list or the customer's new identifier is sent back to the computer being used by the customer. In one embodiment, the customer's computer and the server communicate using a computer network, such as the Internet. The new identifier or the existing list is received by the customer at step 545.

At step 550, the store's server sends a categorized list of the store's items and their prices. This list is received by the customer's computer at step 555. In one embodiment, the categorized list is a web page that is hosted by the server. At step 560, the server sends static coupons and promotions corresponding to items listed in the categorized list and this information is received by the customer's computer system at step 565. In one embodiment, the coupons and promotional information is integrated on a single web page that is served by the server to the customer computer system.

At step 570, the selections within the categorized list are displayed on a display screen connected to the customer's computer system (see FIG. 1 for an example of a categorized list being displayed on a display screen). The customer uses an input device, such as a mouse or keyboard attached to the customer's computer system, to select an item that appears on the list. A determination is made as to whether the customer is finished using the categorized interface that shows the list of available products (decision 580). If the user is not finished, decision 580 branches to “no” branch 582 which loops back to continue displaying selections available and allow the customer to select the various products and categories of products that are available. In one embodiment, when a different category of products is selected, a request is sent to the server and the server responds with a web page that details the products available in the selected category.

This looping continues until the customer is finished shopping (at least finished with this session), at which point decision 580 branches to “yes” branch 584 whereupon, at step 585, the customer's computer sends the identifier and the customer's current list of selected products back to the server. Customer processing thereafter returns at 590. Returning to server processing, at step 595, the server receives and stores the customer's list of selected products, along with the identifier, and stores the information in customer list data store 596. Server processing of preparing a customer's shopping list thereafter ends at 599.

FIG. 6 is a flowchart showing steps taken to choose a store location and compute a path through the store. Processing commences at 600 whereupon, at step 610, the customer's request and identifier are received from a customer. In one embodiment, the request is received at a kiosk located within a store location, whereas in another embodiment, the request and identifier are received from a customer using a computer outside of a store location.

At step 620, the customer's list is retrieved based upon the customer's identifier (the customer's list was previously saved when the customer created the shopping list, see element 595 in FIG. 5 and corresponding text for processing details). A determination is made as to whether the customer's list is large (decision 630). This determination is made in order to decide whether the customer ought to retrieve perishable items towards the end of the shopping trip so that such items do not spoil or melt while the customer is shopping. If the list size is considered large, decision 630 branches to “yes” branch 640 whereupon, at step 650, a flag is set to included perishables toward the end of the list. On the other hand, if the customer's list is not considered large, decision 630 branches to “no” branch 660 whereupon the flag is not set and a normal path order is maintained when traversing the store. In one embodiment, the customer can elect whether to move perishables to the end of the list by selecting an option. In this case, the customer's preference is used regardless of whether the customer's list is large.

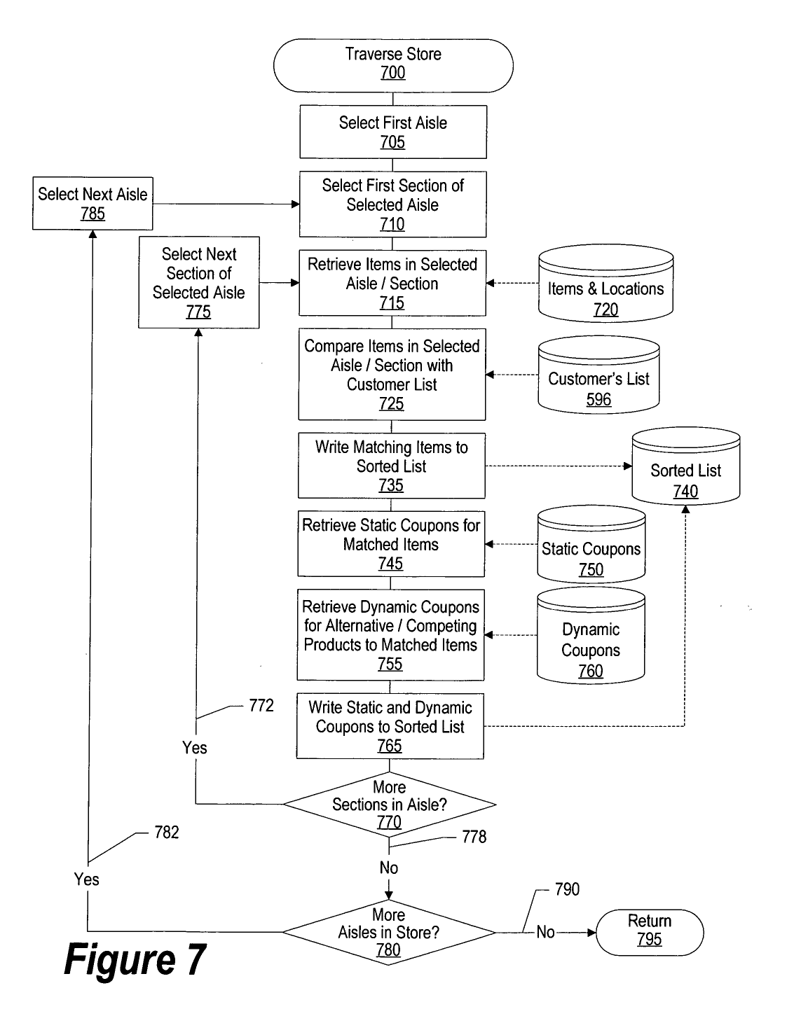

The store location at which the customer wishes to shop is retrieved at step 680. If the customer is using a kiosk within a store, the store location at which the kiosk is located is used. If the customer is using a non-store location, such as the customer's computer at his or her home or office, then the customer selects the store location from a list of possible locations (see FIGS. 2A and 2B for examples of computer-based and kiosk-based screens). Processing next traverses the store for the items selected by the customer in order to create the customer's path and shopping list (predefined process 690, see FIG. 7 and corresponding text for processing details). Processing thereafter returns at 695.

FIG. 7 is a flowchart showing steps taken to traverse the store and retrieve coupon information used to print the list and path through the store. Processing commences at 700 whereupon, at step 705, the first aisle of the store is selected and, at step 710, the first section, such as a shelf, of the first aisle is selected.

At step 715, the items located in the selected aisle and section are retrieved from data store 720. At step 725, the items that were retrieved for the selected aisle and section are matched against items that the customer included in his or her list (customer's list 596). Any matching items are written, at step 735, to sorted list 740.

At step 745, any static coupons that correspond to items that were written in step 735 are retrieved from static coupon data store 750. Likewise, any dynamic coupons for alternative or competing products are retrieved, at step 755, from dynamic coupon data store 760, along with item description information for such alternative or competing products. At step 765, the static and dynamic coupon data is written to sorted list 740.

A determination is made as to whether there are more sections in the aisle (decision 770). If there are more sections, such as shelves, in the aisle, decision 770 branches to “yes” branch 772 and the next section within the selected aisle is selected at step 775. Processing then loops back to match the next section against items the customer included in his or her shopping list, and write such matching items along with any pertinent coupon information to sorted list 740. This looping continues until there are no more sections within the selected aisle, at which point decision 770 branches to “no” branch 778.

When all sections in an aisle have been processed, another determination is made as to whether there are more aisles in the store (decision 780). If there are more aisles in the store, decision 780 branches to “yes” branch 782 whereupon, at step 785, the next aisle is selected and processing loops back to match the sections within the next aisle with the selections that were made by the customer. As previously discussed, certain items, such as perishables, may be flagged for inclusion towards the end of the list. This consideration is included in the selection of the next aisle. For example, if the next aisle contains ice cream and the flag was set to include perishables toward the end of the list, then the aisle is bypassed until all the nonperishable items have been processed. After the nonperishable items have been processed, the aisles that were initially bypassed are processed so that perishable items are included towards the end of the customer's path and list through the store. This looping continues until all aisles in the store have been processed, at which time decision 780 branches to “no” branch 790 and processing returns at 795.

FIG. 8 is a flowchart showing steps taken to print the customer's list, the path, and coupons. Processing commences at 800 whereupon, at step 810, the first item is retrieved from sorted list 740 along with any coupon information that corresponds to the item. At step 815, the location of the item along with the item's description are printed to printout 820. While printout is depicted as a paper document, it is well understood that an electronic printout can be created, such as printing using a format such as Adobe Corporation's Portable Document Format (PDF). Such electronic printout could then be displayed by the customer using a personal digital assistant (PDA) while the customer is shopping.

A determination is made as to whether a static coupon corresponds to the item (decision 825). If there is a static coupon for the item, decision 825 branches to “yes” branch 830 whereupon, at step 835, the static coupon and barcode for the coupon are printed to printout 820. On the other hand, if there is no coupon for the item, decision 825 branches to “no” branch 840 bypassing step 835.

Another determination is made as to whether there are any dynamic coupons for any alternative or competing items (decision 845). If there are any dynamic coupons, decision 845 branches to “yes” branch 850 whereupon, at step 855, the description and location of the competing item is printed to printout 820 and, at step 860, the dynamic coupon information (i.e. the amount of the coupon) is printed to printout 820 along with the barcode for the dynamic coupon. On the other hand, if there are no dynamic coupons that correspond to the item, decision 845 branches to “no” branch 865 bypassing step 855 and 860.

A determination is made as to whether the end of the customer's sorted shopping list has been reached (decision 870). If the end of the list has not been reached, decision 870 branches to “no” branch 875 whereupon, at step 880, the next item from the sorted list is retrieved along with any coupon information for the item and processing loops back to print the item information and any static and/or dynamic coupon information. This looping continues until all items in the customer's list have been processed, at which time decision 870 branches to “yes” branch 890 and processing returns at 895.

FIG. 9 is a flowchart showing steps taken to redeem coupons printed on the printout during checkout. Processing commences at 900 whereupon, at step 905, the total bill amount is initialized to zero. At step 910, the first item in the customer's shopping cart or basket 915 is scanned. At step 920, the price of the scanned item is retrieved from price list 925. At step 930, the UPC of the scanned item is stored in purchased items data store 935. At step 940, the total bill amount is incremented by the amount of the scanned item. A determination is made as to whether there are more items in the customer's shopping cart or basket (decision 945). If there are more items, decision 945 branches to “yes” branch 948 whereupon, at step 950, the next item in cart or basket 915 is scanned and processing loops back to lookup the price, store the item's UPC, and increment the total bill amount. This looping continues until there are no more items in the customer's cart or basket, at which point decision 945 branches to “no”, branch 955 and coupon processing commences.

At step 960, the barcode data (i.e., UPC data) corresponding to the first coupon listed in the customer's shopping list is retrieved from either sorted list 740 or printout 820. If sorted list 740 is being used, the customer identifier corresponding to the list is received from the customer by either manual entry or use of a customer loyalty card. At step 965, the retrieved barcode information is matched against the UPC information, stored in data store 935, of those items that the customer actually selected for purchase. A determination is made as to whether the customer selected the item corresponding to the coupon for purchase based upon whether the UPC information was found in data store 935. If the item was selected for purchase by the customer, then decision 970 branches to “yes” branch 972 whereupon, at step 975, the total bill amount is decremented by the amount of the coupon. On the other hand, if the customer did not select the item for purchase, then decision 970 branches to “no” branch 978 bypassing step 975.

A determination is made as to whether there are more coupons to process from either sorted list 740 or printout 820. If there is more coupon data to process, decision 980 branches to “yes” branch 982 whereupon, at step 985, the barcode information for the next barcode in either sorted list 740 or printout 830 is selected and processing loops back to determine whether the customer selected the corresponding item for purchase. This looping continues until there are no more coupons to process, at which point decision 980 branches to “no” branch 988. When all items and coupons have been processed, the store collects payment for the resulting total bill amount at decision 990. Processing thereafter ends at 995.

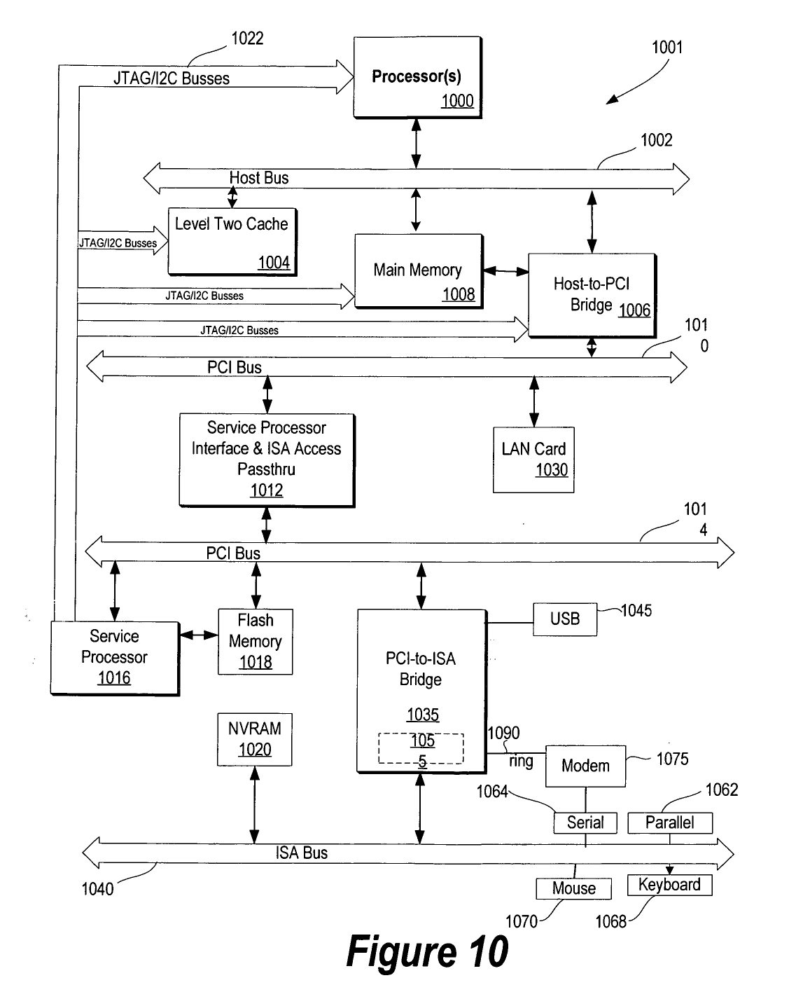

FIG. 10 illustrates information handling system 1001 which is a simplified example of a computer system capable of performing the computing operations described herein. Computer system 1001 includes processor 1000 which is coupled to host bus 1002. A level two (L2) cache memory 1004 is also coupled to host bus 1002. Host-to-PCI bridge 1006 is coupled to main memory 1008, includes cache memory and main memory control functions, and provides bus control to handle transfers among PCI bus 1010, processor 1000, L2 cache 1004, main memory 1008, and host bus 1002. Main memory 1008 is coupled to Host-to-PCI bridge 1006 as well as host bus 1002. Devices used solely by host processor(s) 1000, such as LAN card 1030, are coupled to PCI bus 1010. Service Processor Interface and ISA Access Pass-through 1012 provides an interface between PCI bus 1010 and PCI bus 1014. In this manner, PCI bus 1014 is insulated from PCI bus 1010. Devices, such as flash memory 1018, are coupled to PCI bus 1014. In one implementation, flash memory 1018 includes BIOS code that incorporates the necessary processor executable code for a variety of low-level system functions and system boot functions.

PCI bus 1014 provides an interface for a variety of devices that are shared by host processor(s) 1000 and Service Processor 1016 including, for example, flash memory 1018. PCI-to-ISA bridge 1035 provides bus control to handle transfers between PCI bus 1014 and ISA bus 1040, universal serial bus (USB) functionality 1045, power management functionality 1055, and can include other functional elements not shown, such as a real-time clock (RTC), DMA control, interrupt support, and system management bus support. Nonvolatile RAM 1020 is attached to ISA Bus 1040. Service Processor 1016 includes JTAG and I2C busses 1022 for communication with processor(s) 1000 during initialization steps. JTAG/I2C busses 1022 are also coupled to L2 cache 1004, Host-to-PCI bridge 1006, and main memory 1008 providing a communications path between the processor, the Service Processor, the L2 cache, the Host-to-PCI bridge, and the main memory. Service Processor 1016 also has access to system power resources for powering down information handling device 1001.

Peripheral devices and input/output (I/O) devices can be attached to various interfaces (e.g., parallel interface 1062, serial interface 1064, keyboard interface 1068, and mouse interface 1070 coupled to ISA bus 1040. Alternatively, many I/O devices can be accommodated by a super I/O controller (not shown) attached to ISA bus 1040.

In order to attach computer system 1001 to another computer system to copy files over a network, LAN card 1030 is coupled to PCI bus 1010. Similarly, to connect computer system 1001 to an ISP to connect to the Internet using a telephone line connection, modem 1075 is connected to serial port 1064 and PCI-to-ISA Bridge 1035.

While the computer system described in FIG. 10 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer implemented method comprising:
retrieving a plurality of item selections made by a customer from a nonvolatile storage area;
matching the plurality of item selections to a physical location of each of the item selections within a physical store;
generating, based upon the physical location of each of the item selections, a suggested path through the physical store, wherein the suggested path includes a description of the item selections and the physical location corresponding to the item selections; and
providing the suggested path to the customer to use during shopping at the physical store.

2. The method of claim 1 further comprising:
choosing a physical store from a plurality of physical stores, wherein at least one of the plurality of physical stores has different locations of items from another of the plurality of physical stores; and
retrieving the physical locations based upon the chosen physical store.

3. The method of claim 1 further comprising:
assigning an identifier to the plurality of item selections made by the customer;
receiving the identifier at a computer system running within a kiosk that is located proximate to the physical store, wherein the retrieval of the item selections is based upon the received identifier; and
printing out the suggested path on a printer attached to the kiosk's computer system.

4. The method of claim 1 further comprising:
associating a coupon with one or more of the item selections; and
including coupon information corresponding to the coupon with the suggested path, wherein the coupon information includes a coupon identifier.

5. The method of claim 1 further comprising:
comparing at least one of the items selected with one or more alternative items, wherein the alternative items are not included in the items selected;
selecting one of the alternative items based upon the comparison;
retrieving a description corresponding to the selective alternative item; and
including the alternative item description with the suggested path that is provided to the customer.

6. The method of claim 5 further comprising:
associating a dynamic coupon with the selected alternative item; and
including dynamic coupon information corresponding to the dynamic coupon with the suggested path, wherein the dynamic coupon information includes a coupon identifier.

7. The method of claim 1 further comprising:
including one or more coupon identifiers with the suggested path that is provided to the customer, wherein each of the coupon identifiers corresponds to a coupon amount;
scanning identifiers located on one or more physical items selected for purchase by the customer;
matching the coupon identifiers with the scanned identifiers;
calculating a coupon total by summing the coupon amounts for each coupon that matches one of the scanned identifiers;
reducing a bill total resulting from the scanning of the identifiers by the coupon total.

8. An information handling system comprising:
one or more processors;
a memory accessible by the processors;
a nonvolatile storage area accessible by the processors; and
store path software executed by the operating system, the store path software effective to:
retrieve a plurality of item selections made by a customer from the nonvolatile storage area;
match the plurality of item selections to a physical location of each of the item selections within a physical store;
generate, based upon the physical location of each of the item selections, a suggested path through the physical store, wherein the suggested path includes a description of the item selections and the physical location corresponding to the item selections; and
provide the suggested path to the customer to use during shopping at the physical store.

9. The information handling system of claim 8 further comprising:
receive a selection of a physical store from a plurality of physical stores, wherein at least one of the plurality of physical stores has different locations of items from another of the plurality of physical stores; and
retrieve the physical locations based upon the chosen physical store.

10. The information handling system of claim 8 further comprising:
assign an identifier to the plurality of item selections made by the customer;
receive the identifier at a computer system running within a kiosk that is located proximate to the physical store, wherein the retrieval of the item selections is based upon the received identifier; and
print out the suggested path on a printer attached to the kiosk's computer system.

11. The information handling system of claim 8 further comprising:
associate a coupon with one or more of the item selections; and
include coupon information corresponding to the coupon with the suggested path, wherein the coupon information includes a coupon identifier.

12. The information handling system of claim 8 further comprising:
compare at least one of the items selected with one or more alternative items, wherein the alternative items are not included in the items selected;
select one of the alternative items based upon the comparison;
retrieve a description corresponding to the selective alternative item;
include the alternative item description with the suggested path that is provided to the customer;
associate a dynamic coupon with the selected alternative item; and
include dynamic coupon information corresponding to the dynamic coupon with the suggested path, wherein the dynamic coupon information includes a coupon identifier.

13. The information handling system of claim 8 further comprising:
include one or more coupon identifiers with the suggested path that is provided to the customer, wherein each of the coupon identifiers corresponds to a coupon amount;
scan identifiers located on one or more physical items selected for purchase by the customer;
match the coupon identifiers with the scanned identifiers;
calculate a coupon total by summing the coupon amounts for each coupon that matches one of the scanned identifiers;
reduce a bill total resulting from the scanning of the identifiers by the coupon total.

14. A computer program product stored on a computer operable media, said computer program product comprising software effective to:
retrieve a plurality of item selections made by a customer from a nonvolatile storage area;
match the plurality of item selections to a physical location of each of the item selections within a physical store;
generate, based upon the physical location of each of the item selections, a suggested path through the physical store, wherein the suggested path includes a description of the item selections and the physical location corresponding to the item selections; and
provide the suggested path to the customer to use during shopping at the physical store.

15. The computer program product of claim 14 further comprising:
receive a selection of a physical store from a plurality of physical stores, wherein at least one of the plurality of physical stores has different locations of items from another of the plurality of physical stores; and
retrieve the physical locations based upon the chosen physical store.

16. The computer program product of claim 14 further comprising:
assign an identifier to the plurality of item selections made by the customer;
receive the identifier at a computer system running within a kiosk that is located proximate to the physical store, wherein the retrieval of the item selections is based upon the received identifier; and
print out the suggested path on a printer attached to the kiosk's computer system.

17. The computer program product of claim 14 further comprising:
associate a coupon with one or more of the item selections; and
include coupon information corresponding to the coupon with the suggested path, wherein the coupon information includes a coupon identifier.

18. The computer program product of claim 14 further comprising:
compare at least one of the items selected with one or more alternative items, wherein the alternative items are not included in the items selected;
select one of the alternative items based upon the comparison;
retrieve a description corresponding to the selective alternative item; and
include the alternative item description with the suggested path that is provided to the customer.

19. The computer program product of claim 5 further comprising:
associate a dynamic coupon with the selected alternative item; and
include dynamic coupon information corresponding to the dynamic coupon with the suggested path, wherein the dynamic coupon information includes a coupon identifier.

20. The computer program product of claim 14 further comprising:
include one or more coupon identifiers with the suggested path that is provided to the customer, wherein each of the coupon identifiers corresponds to a coupon amount;
scan identifiers located on one or more physical items selected for purchase by the customer;
match the coupon identifiers with the scanned identifiers;
calculate a coupon total by summing the coupon amounts for each coupon that matches one of the scanned identifiers;
reduce a bill total resulting from the scanning of the identifiers by the coupon total.
